(19) United States
(12) Patent Application Publication
(10) Pub. No.: US 2026/0219939 A1
(43) Pub. Date: Jul. 30, 2026

(54) SCHEDULING OF TASKS USING A BAYESIAN NETWORK

(71) Applicant: INTERNATIONAL BUSINESS MACHINES CORPORATION, ARMONK, NY (US)

(72) Inventors: Nestor Acuna Blanco, Stuttgart (DE); Johannes Staib, Wendlingen (DE); Alexander Merschel, Stuttgart (DE); Michael Magrian, Leonberg (DE)

(21) Appl. No.: 19/078,530

(22) Filed: Mar. 13, 2025

(30) Foreign Application Priority Data
Jan. 30, 2025 (GB) 2501335.0

(51) Int. Cl. G06F 9/50

(52) U.S. Cl. CPC G06F 9/5027

(57) ABSTRACT

A method, computer system, and a computer program product for scheduling execution of tasks is provided. Embodiments may include creating a graph comprising nodes and edges, the nodes associated with respective tasks, wherein each edge indicates an execution relationship between the tasks of two nodes related by an edge. Embodiments may include reversing a direction of each edge resulting in an updated graph. Embodiments may include determining for each node a conditional probability table using a first failure rate of a task of a node and further using a second failure rate of a task of a parent node of the node if the node is a child node. Embodiments may include performing Bayesian inference to compute for each node a respective marginal probability using a respective conditional probability table. The respective marginal probability may be used to determine an execution plan having a highest probability to fail sooner.

### BACKGROUND

The present invention relates to the field of digital computer systems, and more specifically, to a method for scheduling a set of tasks.

Software application testing may involve developing tests based on requirements and running them, typically through scripts, to detect flaws. Automating these tests using available tools may help reduce execution time. However, challenges in execution arise, as tests need to be carefully managed to avoid to unreliable test results, undermining the effectiveness of the automation process.

### SUMMARY

Various embodiments provide a method for scheduling a set of tasks, computer program product, and computer system as described by the subject matter of the independent claims. Advantageous embodiments are described in the dependent claims. Embodiments of the present invention can be freely combined with each other if they are not mutually exclusive.

In one aspect, the invention relates to a method for scheduling execution of a set of tasks, the method comprising: creating a graph comprising nodes and edges, the nodes being associated with the set of tasks respectively, wherein each edge of the graph indicates an execution relationship between the tasks of the two nodes related by the edge; reversing the direction of each edge of the graph for indicating a reversed dependency, resulting in an updated graph; determining for each node in the updated graph a conditional probability table using probabilities defined using a failure rate of the task of the node and further using a failure rate of a task of a parent node of the node if the node is a child node; perform a Bayesian inference to compute for each node of the updated graph a marginal probability using the conditional probability tables; using the marginal probabilities to determine an execution plan having the highest probability to fail sooner.

In one aspect the invention relates to a computer program product comprising a computer-readable storage medium having computer-readable program code embodied therewith, the computer-readable program code configured to implement the method of the above embodiment.

In one aspect the invention relates to a computer system for scheduling execution of a set of tasks, the computer system being configured for: creating a graph comprising nodes and edges, the nodes being associated with the set of tasks respectively, wherein each edge of the graph indicates an execution relationship between the tasks of the two nodes related by the edge; reversing the direction of each edge of the graph for indicating a reversed dependency, resulting in an updated graph; determining for each node in the updated graph a conditional probability table using probabilities defined using a failure rate of the task of the node and further using a failure rate of a task of a parent node of the node if the node is a child node; performing a Bayesian inference to compute for each node of the updated graph a marginal probability using the conditional probability tables; using the marginal probabilities to determine an execution plan having the highest probability to fail sooner.

### BRIEF DESCRIPTION OF THE DRAWINGS

In the following embodiments of the invention are explained in greater detail, by way of example only, making reference to the drawings in which:

FIG. 1 is a flowchart of a method for scheduling a set of tasks in accordance with an example of the present subject matter.

FIG. 2 is a flowchart outlining a scheduling process that manages tasks based on input data, dependencies, and task execution results in accordance with an example of the present subject matter.

FIG. 3A is a flowchart outlining a scheduling process that manages tasks based on input data in accordance with an example of the present subject matter.

FIG. 3B is a diagram illustrating the construction graph based on task dependencies and their failure rates, following the outlined process of FIG. 3A.

FIG. 4 depicts a diagram outlining a task scheduling and execution process using a worker pool with priorities and dependencies in accordance with an example of the present subject matter.

FIG. 5 is a computing environment in accordance with an example of the present subject matter.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present subject matter may have advantages in managing complex systems with dependencies, particularly in task scheduling and failure prediction. By leveraging probabilistic inference, it may mimic a dynamic decision-making based on real-time evidence to increase the likelihood of identifying early failures. This may enable the efficient scheduling of dependent tasks according to their calculated failure rates, ensuring optimal task execution and overall improved system reliability.

The present subject matter may provide a method for scheduling a set of tasks.

A graph may be created. The graph comprises nodes and edges. The nodes are associated with the set of tasks respectively, wherein each edge of the graph indicates an execution relationship between the tasks of the two nodes related by the edge. This may enable the creation of a task dependency graph where nodes represent individual tasks, and edges indicate execution dependencies between them. An edge from node A to node B may signify that task A must be completed before task B. This graph-based structure may provide a clear visualization of task execution order, helping to analyze and understand dependencies systematically.

The direction of each edge of the graph may be reversed for indicating a reversed dependency, resulting in an updated graph.

After creating the initial graph where each node represents a task and each edge indicates the execution relationship between tasks, the method involves reversing the edges. Originally, if an edge pointed from Task A to Task B, indicating that Task A is to be completed before Task B can start, reversing the edge changes this relationship so that Task B “points to” Task A, reflecting a shift to evaluating failure risks or likelihood of success rather than task completion dependencies. In failure analysis, this may mean the initial graph shows execution dependencies (Task A must finish for Task B to start), while the reversed graph illustrates failure or success propagation (how Task B's failure or success might affect Task A). Reversing the edges may shift the perspective from task completion to failure dependency, focusing on how failing a task can impact earlier tasks in the sequence. For example, Task A might be a prerequisite for Task B, but if Task B has a high probability of failure or low probability of success, the reversed edge may signal that risk of failure risk or likelihood of success should propagate backward, affecting how one may assess the failure risk or likelihood of success for Task A. For example, if Task A has a failure probability p1 on its own, but the parent Task B has a much higher failure probability p2, then considering Task A in the context of Task B will lead to an effective increase in p1. For example, in the case of a direct dependency between Task A and Task B a formula to derive p1 may be P(A)+P(B)−P(A)*P(B) indicating that p1 will be increased, and it will be higher than the probability p2. The advantages of reversing the graph may include improved visibility of risk propagation, better decision-making through optimized execution sequences, and early detection of failure-prone tasks to contain failures and use resources efficiently.

It may be determined for each node in the updated graph a conditional probability table using probabilities defined using a failure rate of the task of the node and further using a failure rate of a task of a parent node of the node if the node is a child node.

This may enable the creation of a conditional probability table (CPT) for each task in the updated graph, using the task's failure rate. If a task has parent tasks (i.e., tasks it depends on), the CPT may incorporate the failure rates of these parent tasks to model how their failures influence the likelihood of the current task failing. This probabilistic approach may allow for a detailed understanding of failure dependencies between tasks. This may provide a comprehensive model that factors in both inherent task risks and how failures can propagate through dependent tasks, enabling better risk assessment.

A Bayesian inference may be performed to compute for each node of the updated graph a marginal probability using the conditional probability tables. The marginal probability may be referred to as inference value. For example, the Bayesian inference may result in each node of the updated graph having a respective inference value.

This may enable the use of Bayesian inference to calculate the marginal probability of failure for each task in the updated graph. By leveraging the CPTs, this process may integrate all conditional probabilities to determine the overall likelihood of a task failing, considering the possible failure and success scenarios of related tasks. The result may be an unconditional failure probability for each task. This may provide a more precise risk assessment by accounting for all dependencies and failure rates, aiding in better decision-making regarding task execution and risk management. Indeed, with the reversing, the marginal probabilities may allow a more precise estimate of likelihood of success or failure risk of each task which is used.

An execution plan having the highest probability to fail sooner may be determined using the marginal probabilities. In one example implementation, the execution plan may be determined by the computed inference values from the reversed graph, sorting the values from bigger to lower. In one example implementation, the marginal probabilities may be used to determine one or more candidate execution plans for execution of the set of tasks. Each candidate execution plan indicates at least an order of execution of the set of tasks. This may determine how the marginal probabilities of task failures are used to develop execution plans that may prioritize tasks based on their risk of failure. These plans may reflect different strategies for executing tasks, with each plan may indicate where failures are most likely to occur. These execution plans may provide flexibility, offering multiple strategies to balance priorities like speed and risk tolerance, allowing for informed decisions in task management. And the execution plan of the candidate execution plans having the highest probability to fail sooner may be selected.

This may describe determining or selecting an execution plan that prioritizes tasks most likely to fail early in the process. By choosing a plan that exposes potential failures sooner, issues can be identified and mitigated earlier. The goal may be to implement a strategy, where risky tasks are addressed upfront to avoid investing time and resources in tasks that might ultimately fail. The advantage of this approach may be that it may minimize wasted effort and allow for quicker iteration and error correction.

According to one example, the execution plan indicates the order using a timeline for execution of the set tasks.

The execution plan may provide a timeline for the sequential and/or parallel execution of tasks, essentially mapping out when each task will begin and end based on its dependencies, duration, and available resources. The timeline may visually represent the flow of the entire set of tasks, showing the sequence of tasks and their durations. To construct the timeline, one may first identify the dependencies for each task, for determining which tasks can start immediately and which can only begin after prerequisite tasks are completed. Then, one may estimate the duration for each task to place it accurately on the timeline. Sequential tasks are placed in the correct order, ensuring that tasks dependent on others are scheduled to begin only after the prerequisite tasks are expected to be completed. Additionally, the availability of resources, such as workers, may be factored into the timeline, as resource constraints may affect when tasks can start, even if they could be executed sooner. The advantages of this approach may include providing a clear (e.g., visual) representation of the entire execution process, allowing to identify when tasks are expected to begin and end for improved planning management of resources.

According to one example, the execution plan further indicating along the timeline the tasks that can be executed concurrently.

The execution plan may not only indicate a sequential timeline but also highlight tasks that can be performed concurrently (in parallel), maximizing efficiency and reducing overall execution time. Parallel execution may occur when two or more tasks may run at the same time without interfering with one another. To identify concurrent tasks, the first step may be to analyze task dependencies. If two tasks have no dependencies between them, they can be executed simultaneously. These tasks may then be grouped and shown on the timeline as running in parallel. The advantages of this approach may include increased efficiency, as executing tasks in parallel may reduce the total time required to complete them, and optimal resource utilization, as resources can be allocated to different tasks concurrently rather than waiting for one task to finish.

According to one example, the method further comprises using one or more workers to execute the set of tasks in accordance with the selected execution plan. This method describes using one or more workers to execute the set of tasks according to a selected execution plan. A worker may be an entity, such as a machine, or software process, responsible for performing assigned tasks in a computer system. Workers may operate independently or in coordination with others, executing tasks according to a defined plan that may include sequential or concurrent execution. Workers are assigned tasks in alignment with the execution plan. Workers then execute tasks according to this execution plan, maximizing efficiency through concurrent execution where possible and reducing idle time by balancing task sequences with resource availability.

According to one example, each worker of the workers is configured to execute a task at a time, wherein each free worker of the workers is further configured to select a task that either does not depend on any other tasks or that has all its dependencies successfully completed or has a highest inference value among the set of tasks not yet executed. And the worker may execute the selected task.

This method describes how each worker is configured to execute one task at a time while incorporating a task selection mechanism based on task dependencies. Each worker operates in a single-tasking mode, focusing on completing one task before moving on to the next, ensuring full resource dedication to the current task. Once a worker finishes a task and becomes free, it autonomously selects a new task to execute, based at least on two conditions: the task either has no dependencies or all its dependencies have already been successfully completed. This may ensure that workers respect task dependencies and only begin tasks when they are ready. The selection process may involve checking the task dependency graph to identify available tasks, allowing workers to select tasks independently without centralized assignment. Workers can execute tasks concurrently if the system allows. This method may enable efficient use of workers, where free workers immediately select tasks to avoid idle time. This method may also enable scalability, as more workers can be added without additional configuration.

According to one example, the method further comprises: using the selected execution plan for execution of the set of tasks.

According to one example, the set of tasks are operating system processes, the set of tasks enabling development or test of the operating system.

According to one example, the graph is a direct acyclic graph (DAG).

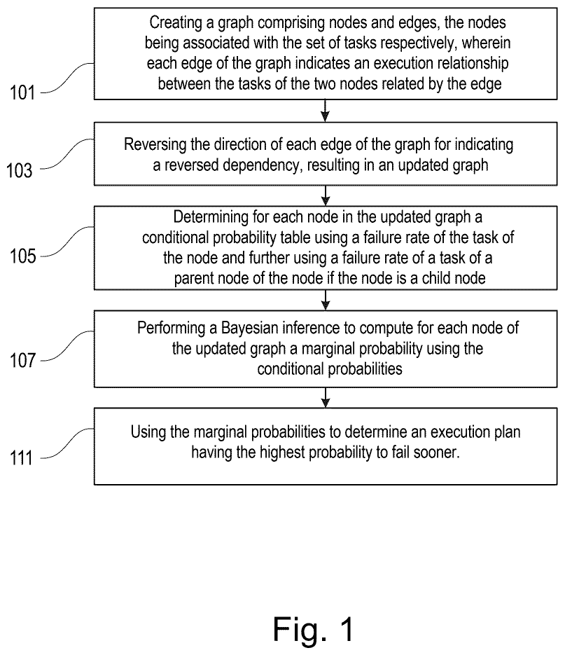

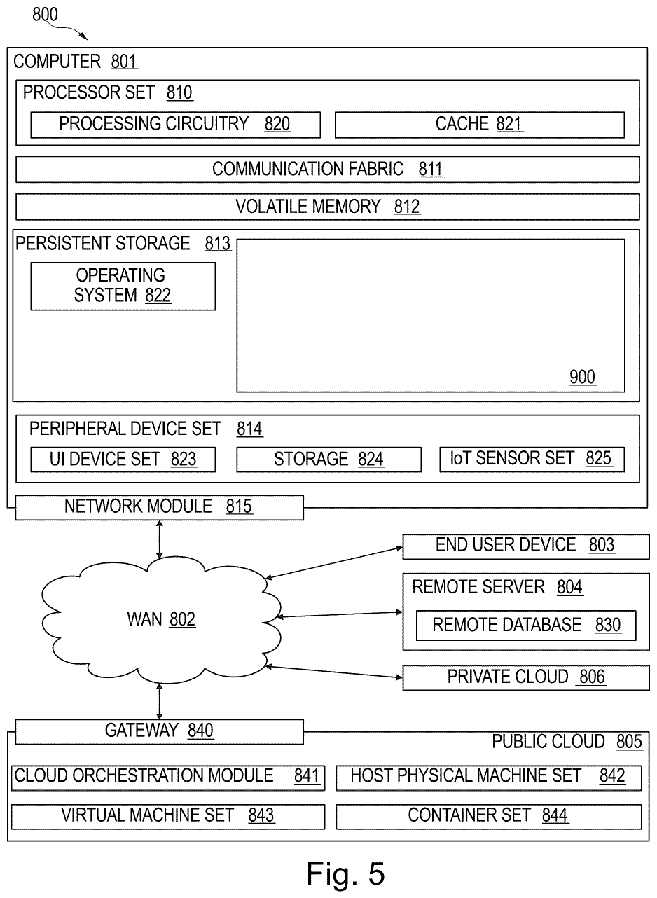

FIG. 1 is a flowchart of a method for scheduling a set of tasks in accordance with an example of the present subject matter. For the purpose of explanation, the method described in reference to FIG. 1 may be implemented in an apparatus such as the apparatus illustrated and described in reference to FIG. 5 but is not limited to this implementation.

A graph comprising nodes and edges may be created in step 101. The nodes are associated with the set of tasks respectively, wherein each edge of the graph indicates an execution relationship between the tasks of the two nodes related by the edge.

The direction of each edge of the graph may be reversed in step 103 for indicating a reversed dependency, resulting in an updated graph.

For each node in the updated graph, a conditional probability table may be determined in step 105 using a failure rate of the task of the node and further using a failure rate of a task of a parent node of the node if the node is a child node.

A Bayesian inference may be performed in step 107 to compute for each node of the updated graph a marginal probability using the conditional probability tables.

The marginal probabilities may be used in step 111 to determine an execution plan having the highest probability to fail sooner (or having the highest likelihood of failing earlier).

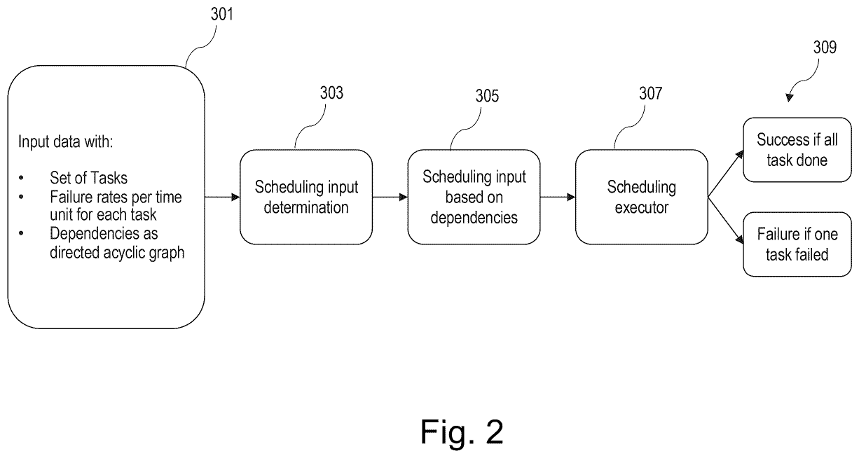

FIG. 2 is a flowchart outlining a scheduling process that manages tasks based on input data, dependencies, and task execution results. In step 301, the process starts with input data that contains information for task scheduling. The data includes a set of tasks to be executed in parallel or in sequence (per time unit), with dependencies clearly defined for each task. These dependencies are structured as a DAG, ensuring that tasks are executed in an order that respects their interdependencies. In step 303, based on the input data, a scheduling input may be determined. It may identify which tasks need to be scheduled at what times. The scheduling input determination step may prepare a task execution plan according to the input data provided in step 301.

In step 305, after determining the scheduling input, tasks are scheduled for execution while considering their dependencies, ensuring that task execution adheres to the defined dependencies and order. This may mean that a task can only be scheduled for execution if all its dependent tasks have been successfully completed. In step 307, the scheduling executor manages the actual execution of tasks as per the scheduling plan from step 305. It may monitor the status of each task and handle them according to their dependencies and available resources. Task completion may be tracked to ensure the execution flow proceeds as expected.

In step 309, once the tasks have been executed, their results are evaluated. If all tasks complete successfully, the process indicates a “success” outcome. However, if any task fails, the process will report a “failure” and halt further task execution.

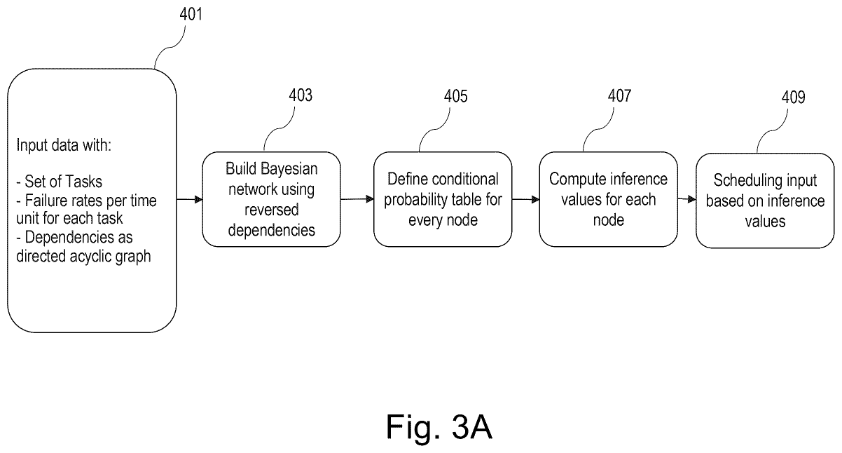

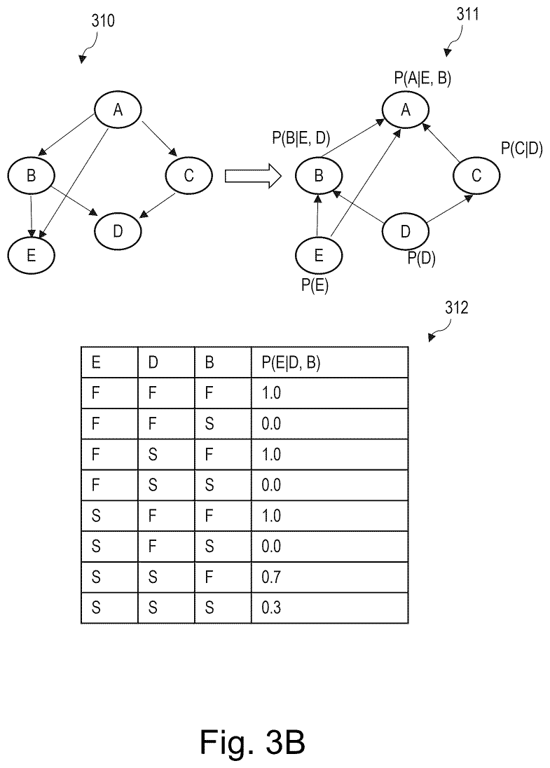

FIG. 3A is a flowchart outlining a scheduling process that manages tasks based on input data. In step 401, the process begins with input data that contains information about tasks, including set of tasks and dependencies structured as a DAG, which dictates the execution order of tasks. In step 403, based on the task dependencies from the input data, a Bayesian network is built using inverted task dependencies, where each task in the DAG is a node, and edges represent reversed task dependencies. In step 405, a CPT is defined for each node, encoding the likelihood of a task's success or failure based on the states of its dependent tasks. In step 407, inference values may be computed for each node by updating the posterior probabilities based on the observed evidence and relationships encoded in the CPTs. Finally, in step 409, task scheduling is performed based on the inference values (e.g., the higher the inference value, the higher the priority assigned to the corresponding task), ensuring tasks are executed in the correct order with consideration for their likelihood of success, as computed through inference.

FIG. 3B is a diagram illustrating the construction of a graph based on task dependencies and their failure rates, following the outlined process of FIG. 3A. A set of tasks or tests, denoted as x1, . . . , xn are provided, each with an associated failure rate per time unit r1, . . . , rn. Additionally, the dependencies between these tasks may be represented in a directed acyclic graph, where edges (xi, xj) indicate that task xi must be completed before task xj begins.

The diagram shows an original task dependency graph 310, where tasks A, B, C, D and E are represented as nodes respectively, and the arrows represent the dependencies between them. For example, task B must be completed before tasks E and D can proceed. To create the updated graph 311, the dependencies may be reversed so the edges are directed in reverse. This reversal may enable to perform probabilistic inference in the Bayesian network because it may align the direction of inference with the direction of dependency propagation. For each variable xi (task) and its parent variables pai (dependent tasks), a CPT 312 may be constructed. This table 312, shown in the diagram, represents the conditional probability distribution of task E, given the outcomes of tasks D and B. For example, the table 312 shows that if both tasks D and B fail, the probability of E failing is 1.0 (certain failure), while if both tasks succeed, the probability of E failing drops to 0.7.

The updated graph 311 may be used as a Bayesian network, which may compute the posterior marginal probabilities of each variable considering the task dependencies and the prior failure rates of the tasks. These posterior marginals may help determine the likelihood of task failure and success, considering the status of the dependent tasks. To compute the posterior marginals P(xi), any probabilistic inference algorithm for Bayesian networks, such as Variable Elimination (VE), Iterative Belief Propagation (IBP), or Weighted Mini-Buckets (WMB) may be used. These algorithms calculate the updated probabilities of task failure or success after accounting for the observed outcomes of other tasks. The posterior marginals may then be used to develop a scheduling plan (or execution plan) that prioritizes tasks likely to fail early, with tasks having higher inference values being scheduled earlier to address potential problems more efficiently.

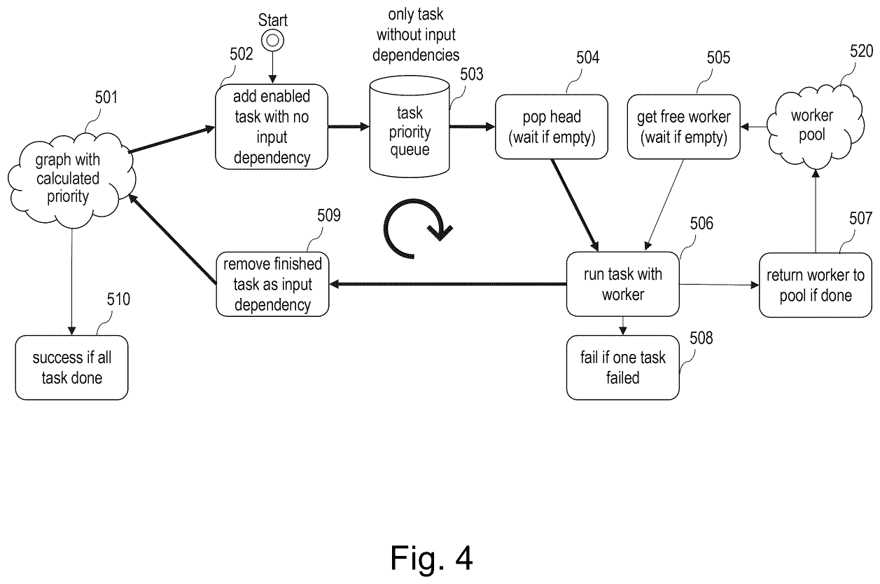

FIG. 4 depicts a diagram outlining a task scheduling and execution process using a worker pool with priorities and dependencies.

The process begins at step 501, where a graph with calculated priorities is created to manage task dependencies. Then, at step 502, tasks without input dependencies are added to the task priority queue (503). The process proceeds to step 504, where the highest-priority task is popped from the queue (if the queue is not empty, the process waits). In 505, the process retrieves a free worker from the worker pool (520), waiting if no worker is available. The selected task is executed with the assigned worker at step 506. If any task fails during execution, the process triggers a failure action at step 508, resulting in termination. After the successful completion of the task, the process removes the finished task as an input dependency for other tasks at step 509, allowing dependent tasks to proceed. The completed worker is then returned to the worker pool at step 507 for reuse in subsequent tasks. The process may end in step 510, where the process determines the overall success where all tasks were executed successfully. The task priority queue (503), worker pool (520), and the graph with calculated priorities (501) may be components, used for orchestrating task scheduling and ensuring efficient resource allocation while handling dependencies and potential failures.

The present subject matter may comprise the following clauses.

Clause 1. A method for scheduling execution of a set of tasks, the method comprising: creating a graph comprising nodes and edges, the nodes being associated with the set of tasks respectively, wherein each edge of the graph indicates an execution relationship between the tasks of the two nodes related by the edge; reversing the direction of each edge of the graph for indicating a reversed dependency, resulting in an updated graph; determining for each node in the updated graph a conditional probability table using probabilities defined using a failure rate of the task of the node and further using a failure rate of a task of a parent node of the node if the node is a child node; performing a Bayesian inference to compute for each node of the updated graph a marginal probability using the conditional probability tables; using the marginal probabilities to determine an execution plan having the highest probability to fail sooner.

Clause 2. The method of clause 1, the execution plan indicating the order using a timeline for execution of the set tasks.

Clause 3. The method of clause 2, the execution plan further indicating along the timeline the tasks that can be executed concurrently.

Clause 4. The method of any of the preceding clauses 1 to 3, further comprising using one or more workers to execute the set of tasks in accordance with the selected execution plan.

Clause 5. The method of clause 4, wherein each worker of the workers is configured to execute a task at a time, wherein for executing a task, each worker of the workers is further configured to select a task that either does not depend on any other tasks or that has all its dependencies successfully completed and execute the selected task.

Clause 6. The method of any of the preceding clauses 1 to 5, further comprising using the selected execution plan for execution of the set of tasks.

Clause 7. The method of any of the preceding clauses 1 to 6, the set of tasks being operating system processes, the set of tasks enabling development or test of the operating system.

Clause 8. The method of any of the preceding clauses 1 to 7, the graph being a direct acyclic graph.

Clause 9. A computer system for scheduling execution of a set of tasks, the computer system being configured for: creating a graph comprising nodes and edges, the nodes being associated with the set of tasks respectively, wherein each edge of the graph indicates an execution relationship between the tasks of the two nodes related by the edge; reversing the direction of each edge of the graph for indicating a reversed dependency, resulting in an updated graph; determining for each node in the updated graph a conditional probability table using probabilities defined using a failure rate of the task of the node and further using a failure rate of a task of a parent node of the node if the node is a child node; performing a Bayesian inference to compute for each node of the updated graph a marginal probability using the conditional probability tables; using the marginal probabilities to determine an execution plan having the highest probability to fail sooner.

Clause 10. The computer system of clause 9, the execution plan indicating the order using a timeline for execution of the set tasks.

Clause 11. The computer system of clause 10, the execution plan further indicating along the timeline the tasks that can be executed concurrently.

Clause 12. The computer system of any of the preceding clauses 9 to 11, being further configured for using one or more workers to execute the set of tasks in accordance with the selected execution plan.

Clause 13. The computer system of clause 12, comprising the workers, wherein each worker of the workers is configured to execute a task at a time, wherein for executing a task, each worker of the workers is further configured to select a task that either does not depend on any other tasks or that has all its dependencies successfully completed or has a highest inference value among the set of tasks not yet executed and execute the selected task.

Clause 14. The computer system of any of the preceding clauses 9 to 13, being further configured for using the selected execution plan for execution of the set of tasks.

Clause 15. The computer system of any of the preceding clauses 9 to 14, the set of tasks being operating system processes, the set of tasks enabling development or test of the operating system.

Clause 16. The computer system of any of the preceding clauses 9 to 15, the graph being a direct acyclic graph.

Computing environment 800 contains an example of an environment for the execution of at least some of the computer code involved in performing the inventive methods, such as code 900 for scheduling a set of tasks. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 5. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

CLOUD COMPUTING SERVICES AND/OR MICROSERVICES (not separately shown in FIG. 5): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim.”A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

What is claimed is:

1. A method for scheduling execution of a set of tasks, the method comprising:
creating a graph comprising nodes and edges, the nodes being associated with the set of tasks respectively, wherein each edge of the graph indicates an execution relationship between the set of tasks of two nodes related by an edge;
reversing a direction of each edge of the graph for indicating a reversed dependency, resulting in an updated graph;
determining for each node in the updated graph a conditional probability table using probabilities defined using a first failure rate of a task of a node and further using a second failure rate of a task of a parent node of the node if the node is a child node;
performing a Bayesian inference to compute for each node of the updated graph a respective marginal probability using a respective conditional probability table; and
using the respective marginal probability for each node to determine an execution plan having a highest probability to fail sooner.

2. The method of claim 1, the execution plan indicating an order using a timeline for execution of the set of tasks.

3. The method of claim 2, the execution plan further indicating along the timeline the tasks that can be executed concurrently.

4. The method of claim 1, further comprising using one or more workers to execute the set of tasks in accordance with the execution plan.

5. The method of claim 4, wherein each worker of the one or more workers is configured to execute a respective task at a time, wherein for executing the respective task, each worker of the one or more workers is further configured to select the respective task that either does not depend on any other tasks or that has all its dependencies successfully completed to execute the selected respective task.

6. The method of claim 1, further comprising using the execution plan for execution of the set of tasks.

7. The method of claim 1, the set of tasks being operating system processes, the set of tasks enabling development or test of an operating system.

8. The method of claim 1, the graph being a direct acyclic graph.

9. A computer program product comprising a computer-readable storage medium having computer-readable program code embodied therewith, the computer-readable program code configured to implement a method comprising:
creating a graph comprising nodes and edges, the nodes being associated with a set of tasks respectively, wherein each edge of the graph indicates an execution relationship between the set of tasks of two nodes related by an edge;
reversing a direction of each edge of the graph for indicating a reversed dependency, resulting in an updated graph;
determining for each node in the updated graph a conditional probability table using probabilities defined using a first failure rate of a task of a node and further using a second failure rate of a task of a parent node of the node if the node is a child node;
performing a Bayesian inference to compute for each node of the updated graph a respective marginal probability using a respective conditional probability table; and
using the respective marginal probability for each node to determine an execution plan having a highest probability to fail sooner.

10. A computer system for scheduling execution of a set of tasks, the computer system being configured for:
creating a graph comprising nodes and edges, the nodes being associated with the set of tasks respectively, wherein each edge of the graph indicates an execution relationship between the set of tasks of two nodes related by an edge;
reversing a direction of each edge of the graph for indicating a reversed dependency, resulting in an updated graph;
determining for each node in the updated graph a conditional probability table using probabilities defined using a first failure rate of a task of a node and further using a second failure rate of a task of a parent node of the node if the node is a child node;
performing a Bayesian inference to compute for each node of the updated graph a respective marginal probability using a respective conditional probability table; and
using the respective marginal probability for each node to determine an execution plan having a highest probability to fail sooner.

11. The computer system of claim 10, the execution plan indicating an order using a timeline for execution of the set tasks.

12. The computer system of claim 11, the execution plan further indicating along the timeline the tasks that can be executed concurrently.

13. The computer system of claim 10, being further configured for using one or more workers to execute the set of tasks in accordance with the execution plan.

14. The computer system of claim 13, comprising the one or more workers, wherein each worker of the one or more workers is configured to execute a respective task at a time, wherein for executing the respective task, each worker of the one or more workers is further configured to select the respective task that either does not depend on any other tasks or that has all its dependencies successfully completed or has a highest inference value among the set of tasks not yet executed to execute the selected respective task.

15. The computer system of claim 10, being further configured for using the execution plan for execution of the set of tasks.

16. The computer system of claim 10, the set of tasks being operating system processes, the set of tasks enabling development or test of an operating system.

17. The computer system of claim 10, the graph being a direct acyclic graph.
